(19) United States
(12) Patent Application Publication
(10) Pub. No.: US 2014/0169130 A1
(43) Pub. Date: Jun. 19, 2014

(54) Methods and Apparatus for Waveform Processing

(71) Applicant: SCHLUMBERGER TECHNOLOGY CORPORATION, Sugar Land, TX (US)

(72) Inventors: Shuchin Aeron, Brookline, MA (US); Sandip Bose, Brookline, MA (US); Henri-Pierre Valero, Yokohama-shi (JP)

(73) Assignee: SCHLUMBERGER TECHNOLOGY CORPORATION, Sugar Land, TX (US)

(21) Appl. No.: 13/712,971

(22) Filed: Dec. 13, 2012

(51) Int. Cl. G01V 1/48

(52) U.S. Cl. CPC G01V 1/48
USPC 367/31

(57) ABSTRACT

Methods and apparatus for waveform processing are disclosed. An example method includes representing waveform data using space time propagators in the Discrete Radon Transform Domain. The method also includes identifying signals within the represented waveform data using a Sparisty Penalized Transform.

### BACKGROUND

Waveform data may be obtained while drilling. However, because different waveforms may arrive at at similar times, differentiating between weak signals may be difficult.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

An example method includes representing waveform data using space time propagators in the Discrete Radon Transform Domain. The example method also includes identifying signals within the represented waveform data using a Sparsity Penalized Transform.

An example method includes processing waveform data using a processor to identify one more weak signals in the waveform data. The weak signals to be identified using a Sparsity Penalized Transform.

An example apparatus includes sources spaced from receivers. The sources to transmit signals and the receivers to receive at least a portion of the signals. The apparatus includes a processor to process waveform data to identify weak signals in the waveform data. The waveform data is associated with the signals. The weak signals are to be identified using a Sparsity Penalized Transform.

### BRIEF DESCRIPTION OF THE DRAWINGS

Embodiments of systems and methods for waveform processing are described with reference to the following figures. The same numbers are used throughout the figures to reference like features and components.

FIG. 1 illustrates an example space time propagator.

FIG. 2 illustrates an example workflow for constructing space time propagators.

FIG. 3 depicts an example workflow to implement the examples disclosed herein.

FIG. 4 depicts two propagating modes.

FIG. 5 depicts a superposition of the two modes of FIG. 4 including noise.

FIG. 6 depicts a Radon Transform and slowness-time-coherence plots of the data of FIG. 5.

FIG. 7 illustrates a high resolution Radon map obtained using the examples disclosed herein.

FIG. 8 illustrates logging-while-drilling monopole data.

FIG. 9 illustrates results of the examples disclosed herein.

FIG. 10 illustrates an example system in which embodiments of the methods and apparatus for waveform processing may be implemented.

FIG. 11 illustrates another example system in which embodiments of the methods and apparatus for waveform processing may be implemented.

FIG. 12 depicts an example process that can be implemented using the example apparatus for waveform processing.

FIG. 13 is a schematic illustration of an example processor platform that may be used and/or programmed to implement any or all of the example methods are apparatus disclosed herein.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

Accurate and/or reliable slowness estimates of waveform data are important in seismic exploration and/or Petroleum Exploration and Production (PEP). However, when sensors are placed in a borehole and/or on an acoustic logging tool, the array aperture used to increase the resolution and estimate propagating wavefields may be limited. The examples disclosed herein provide a general framework to enable high resolution move-out and/or slowness dispersion estimates for sonic data obtained by low array apertures. In some examples, to enable data to be represented as a superposition of the propagating wavefields, a Discrete Radon Transform (DRT) is used and a dictionary of space time propagators is generated and/or used. The data synthesized from these space time propagators may be represented in terms of a coefficient vector exhibiting sparsity in the Radon domain, that is, having a few non-zero elements. The sparsity may be used in connection with a complexity penalized algorithm for move-out estimation.

In contrast to some known approaches, the examples disclosed herein use a parametric approach and a formulation based on reconstructing a sparse signal from a limited number of observations and/or measurements. The observations and/or measurements are received from a limited number of receivers present in the borehole. Additionally, the examples disclosed herein use sparsity driven estimation and detection methods using simultaneous sparsity (e.g., a mixed l₁ and l₂) that robustly detects weak signals by penalizing the energy in the time window instead of only penalizing the amplitude by a l₁ penalty.

The examples disclosed herein may be used in connection with dispersive and/or non-dispersive signals with linear and/or non-linear move-outs. Additionally and/or alternatively, the examples disclosed may be used to represent acoustic data in terms of linear superposition of broadband propagators. In some examples, weak signals in the presence of relatively strong interference may be detected using a Sparsity Penalized Radon Transform (SPRT) algorithm that identifies and/or uses sparsity in the Radon domain. Equation 1 is a simplified signal model for acquisition at an array of L receivers used to represent non-dispersive signals with general (linear or non-linear) moveout. Referring to Equation 1, y₁(t) corresponds to the received data at the l^{th} receiver, sₖ corresponds to the k^{th} propagating signal and/or arrival received at the reference receiver at location z₀ and Δtₗ(θₘ) corresponds to the arrival time delay at the l^{th} receiver relative to the reference receiver. The arrival time delay is a function of a propagation parameter, θₖ, and the location zₗ of the l^{th} receiver and wₗ(t) represents noise. In logging while drilling (LWD) monopole sonic logging, slowness or linear moveout is the moveout parameter, θₖ, for head waves. In seismic applications, the moveout parameter, θₖ, may correspond to non-linear moveout parameters such as those characterizing reflections.

yₗ(t)=Σₖ₌₁^{K}Sₖ(t−Δtₗ(θₖ))+wₗ(t),l=0, . . . L−1 Equation 1

Equation 2 is a signal model (e.g., a first order approximation) for dispersive signals with linear move-out, where k_{θ} corresponds to the wavenumber dispersion characterized by parameters, θ. For higher order LWD sonic data, such as dipole data and/or quadrupole data, the moveout parameter, θₖ, may be parameterized by phase and group slowness in a given frequency band. It may be assumed that amplitude variation across the array due to geometric spreading and attenuation is negligible and may be ignored. However, in other examples, attenuation may be introduced as an additional parameter.

yₗ(t)=Σₖ₌₁^{K}∫_{f}e^{j2πft}Sₖ(f)e^{-j2πK}^{_{θK}}^{(f)(z}^{ₗ}^{-z}^{₀}⁾df+wₗ(t) Equation 2

Using Equations 1 and 2 and the data obtained at the receivers, l, the moveout parameter, θₖ, may be estimated and the model order may or may not be known.

In an LWD monopole application, the head wave arrival may be assumed to be effectively separated from the Stoneley arrival by high pass filtering, time windowing and/or using velocity filtering in a frequency band around the Stoneley slowness. Equation 3 represents the signal model for such a case, where t, c and sh represent the respective tool, compressional and shear modes, p_{(.)} represents the corresponding slowness or linear move-out and τ_{(.)} represents a central time location or arrival. In fast formations, the tool mode may arrive at approximately the same time as the compressional mode in the slowness time domain causing inaccurate slowness estimation of the formation compressional. Additionally, the compressional mode may become relative weak. In very fast formations, the shear arrival may interfere with the compressional arrival (after filtering), which could bias the slowness estimates and/or lead to loss of detection of the compressional arrivals.

yₗ(t)=sₜ(t−pₜ(zₗ−z₁))+s_{c}(t−p_{c}(zₗ−z₁)−τ_{c})+sₛₕ(t−pₛₕ(t−pₛₕ(zₗ−z₁)−τₛₕ)+wₗ(t) Equation 3

Because of the time compactness of the propagating waves, a framework may be used to represent the acoustic data in terms of space time propagators. To construct the space time propagators, a waveform, ψ_{T}^{Z}₀(t), may be obtained at a receiver, z₀, with a time concentration, T, around a central time location, τ, with a frequency concentration in the band, F. It may be assumed without loss of generality that data (e.g., the waveform data) is filtered to be in the frequency band, F, and/or that most of the signal is concentrated in the frequency band, F.

Equation 4 represents the propagated waveform, φ_{zl}(t), at receiver location, zₗ, for a non-dispersive signal given a propagating parameter, θ, and a fixed τ.

φ_{zl}(t)=ψ_{T}^{Z}₀(t−Δtₗ(θ)(zₗ−z₀)) Equation 4

Equation 5 represents the propagated waveform, φ_{zl}(t), at receiver location, zₗ for a dispersive signal given a propagating parameter, θ, and a fixed τ.

φ_{zl}(t)=∫ψ_{T}^{z}₀(f)e^{-j2πk}_{θ}^{(f)(z}ₗ^{-z}₀⁾e^{j2}πft_{df} Equation 5

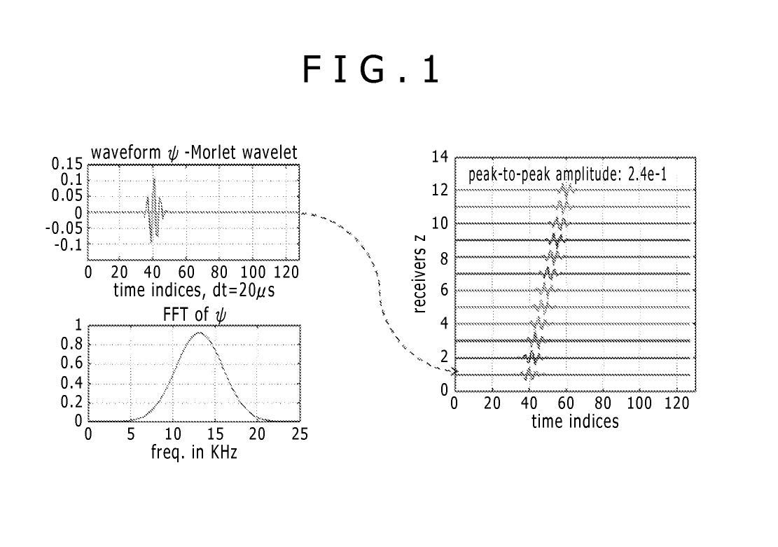

In some examples, as represented in FIG. 1, a non-dispersive and non-attenuating space time propagator at a given slowness, p, can be constructed using Equations 4 and/or 5 if θ=p. Specifically, FIG. 1 illustrates an example space time propagator, π_{z0}(τ,θ), in which the Morlet wavelet is the time-frequency compact waveform at the reference receiver. In FIG. 1, θ=p and equivalently k(f)=pf.

Equation 6 represents a space time propagator with a signature waveform, ψ, central time location, τ, at a reference receiver and propagating with a move-out and/or slowness dispersion parameterized by θ, so as to generate a collection of waveforms propagated to L receivers.

$${τ}_{{z}_{0}} ( τ , θ ) = [ \begin{matrix}{φ}_{{z}_{0}} ( τ , θ ) \\ {φ}_{{z}_{1}} ( τ , θ ) \\ ⋮ \\ {φ}_{{z}_{L}} ( τ , θ )\end{matrix} ] \qquad Equation 6$$

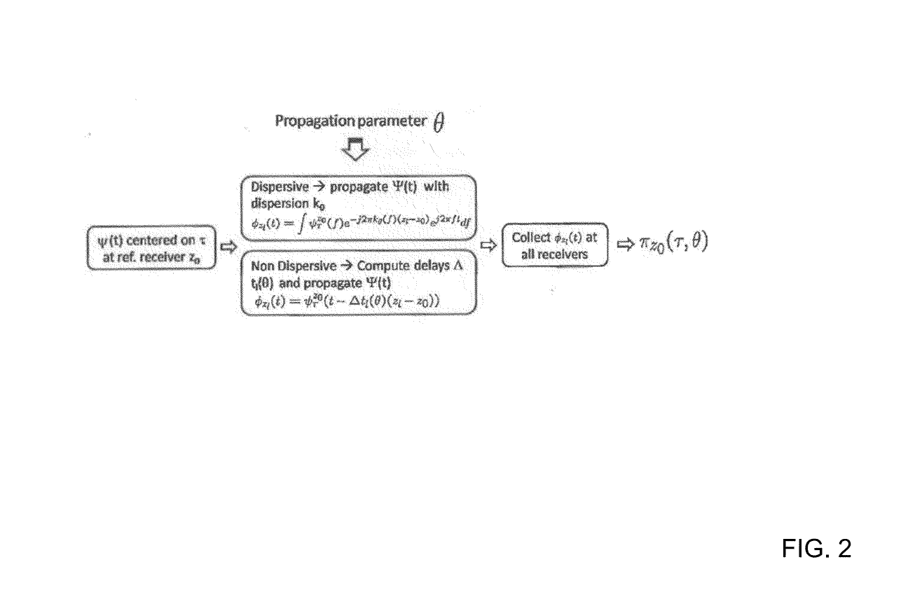

FIG. 2 illustrates a work flow that may be used to construct space time propagators to represent data.

Different time frequency compact waveforms, ψ, may be used depending on the application and the information about the spectral content of the data. For a time sampled system, some examples that may be used include Morlet wavelets, Prolate Spheroidal Wave Functions (PSWF) and/or waveforms having coefficients equal to the FIR filter coefficients where the FIR filter is designed as and/or configured as a pass-band, F. In examples in which the data is pre-filtered using a FIR filter, such as in LWD applications, the corresponding coefficients may be used to construct the space time propagators. While sinc functions are appropriate for bandlimited time sampled systems, such functions may not be sufficiently time concentrated for performing the examples disclosed herein.

Equation 7 illustrates a collection of space time propagators, π_{z0}(τ,θ), over a given time support, τ, of central time locations, T, spanning a given support, Tₛᵤₚₚ.

π_{zo}(τ,θ)={π_{zo}(τ,θ)}_{τετ} Equation 7

Equation 8 illustrates the representation of a mode with a move-out and/or slowness dispersion characterized by θ and a time support, Tₛᵤₚₚ, using the collection of space time propagators, π_{zo}(τ,θ), where a time compact representation over T can be expressed in terms of a vector, x_{Σ,z}_{₀}, which can be identified with the mode coefficients at the reference receiver as represented in Equation 9.

S=Σ_{τεT}π_{z0}(τ,θ)x_{τ,z}_{₀} Equation 8

S_{z0}(t)=Σ_{τεT}ψ_{τ}^{z}^{₀}(t)x_{t z}_{₀} Equation 9

In some examples, if S_{z}_{₀}(t) is approximately time compact in that the signal envelope decays rapidly to zero around a peak value, then the coefficients, x_{τ,z}_{₀}, will have the same property. In some examples, the time support, T, of the signature waveform, ψ, is different than the time support of the signature waveform, used for the modal representation and the two quantities are chosen substantially independently of one another.

The examples disclosed herein use the Discrete Radon Transform (DRT) in terms of a proposed construction of space time propagators. The space time propagators, π_{z0}(τ,θ) may be collected for all τε[0,T] and θεΘ where Θ corresponds to a discrete collection of propagating parameters including a collection of slowness, dispersion curves and/or moveout trajectories. The collected propagators corresponding to each τεT and θεΘ may be in a matrix, R(T, Θ), represented in Equation 10 below, where N_{T} and N_{Θ} are the number of elements in T and Θ, respectively.

R(T,θ)=[π_{z0}(τ₁,θ₁),π_{z0}(τ₁,θ₂) . . . π_{z0}(τ₁,θ_{NΘ})π_{z0}(τ₂,θ₁) . . . π_{z0}(τ_{N}_{_{T}},θ_{NΘ}) Equation 10

In some examples, the forward DRT applied to the data {y₁(t)}_{l=0, . . . , L-1}, is represented by Equation 11, where † is the conjugate transpose. The Data may be restricted to the move-outs and/or slowness dispersion and time locations in the collection R.

\tilde{X}=R(τ,Θ)^{†}Y Equation 11

The received waveform data, yₗ(t,l=0, . . . L−1, and the forward DRT coefficients, x(τ,θ), τεT, θεΘ, may be collected in arrays as represented in Equations 12 and 13.

$$\begin{matrix}Y = [ \begin{matrix}{y}_{0} ( t ) \\ {y}_{1} ( t ) \\ ⋮ \\ {y}_{L - 1} ( t )\end{matrix} ] , \\ X = [ \begin{matrix}x ( {τ}_{1} , {θ}_{1} ) & x ( {τ}_{2} , {θ}_{1} ) & … & x ( {τ}_{{N}_{T}} , {θ}_{1} ) \\ x ( {τ}_{1} , {θ}_{2} ) & x ( {τ}_{2} , {θ}_{2} ) & … & x ( {τ}_{{N}_{T}} , {θ}_{2} ) \\ ⋮ & ⋮ & ⋱ & ⋮ \\ x ( {τ}_{1} , {θ}_{{N}_{Θ}} ) & x ( {τ}_{2} , {θ}_{Θ} & … & x ( {τ}_{{N}_{T}} , {θ}_{{N}_{Θ}} )\end{matrix} ] & Equation 12 \\ \tilde{X} = [ \begin{matrix}X ( {τ}_{1} , \cdot ) \\ X ( {τ}_{2} , \cdot ) \\ ⋮ \\ X ( {τ}_{{N}_{T}} , \cdot )\end{matrix} ] , \\ X ( {τ}_{i} , \cdot ) = [ \begin{matrix}x ( {τ}_{i} , {θ}_{1} ) \\ x ( {τ}_{i} , {θ}_{2} ) \\ ⋮ \\ x ( {τ}_{i} , {θ}_{{N}_{Θ}} )\end{matrix} ] & Equation 13\end{matrix}$$

Equation 14 illustrates that the DRT at time, τ, and the parameter, θ, is given by their inner product.

x(τ,θ)=π_{z0}(τ,θ)^{†}Y Equation 14

In some examples, if the number of receivers, L is relatively large, then the forward DRT has relatively high move-out resolution. However, when the number of receivers is relatively small, then the forward DRT has relatively low move-out resolution. To enable high resolution DRT reconstruction when there are closely propagating wavefields and/or waveforms, an example method and/or algorithm may be used that uses sparsity in the DRT domain in the propagating parameter domain.

The examples disclosed here may be used to measure signal sparsity. For any signal, Xε [symbol] ⁿ, sparsity may be defined in terms of signal support and/or the number of signals (or coefficients in a representation) where the signal has a non-zero amplitude. For example, a signal may be considered sparse if ∥X∥₀=k<<n, where ∥.∥₀ corresponds to the l₀ norm, which is a count of the number of non-zero elements in X.

Additionally, the examples disclosed herein may be used to measure simultaneous sparsity. In some examples, a signal, Xε [symbol] ^{m}*ⁿ, has simultaneous sparsity if the underlying signal has few occupied rows in that ∥X∥_{0,2}<<m where ∥X∥_{0,2}=∥X_{rN}∥₀, and X_{rN} is a vector, rownorm(X), whose i^{th} element is the l₂ norm of the i^{th} row in X, X_{rN}(i)=\sqrt{Σⱼ₌₁ⁿ|Xᵢⱼ∥²}. Similar and/or equivalent definitions may be applied to column sparsity. In the examples disclosed herein, because the number of modes is small, the forward Radon transform (τ-p domain) has row sparsity.

The examples disclosed herein may use the Sparsity Penalized Reconstruction algorithm and sparsity in the Θ dimension in the DRT domain. If the data, =[yl(t)]_{l=0, . . . , L-1} is provided, the SPRT includes finding the solution to the optimization problem of Equation 15 over X, where σₙ² corresponds to the total noise variance and k may be selected based on the problem parameters to limit the permissible error in the data fit relative to the noise variance. In some examples, the mixed norm, ∥X∥_{0,2}, includes taking the l₂ norm along the temporal dimension of the Radon transform coefficients and the l₀ norm along the propagator parameter dimension. Equation 15 illustrates that the sparsity in the number of modes is penalized with respect to the energy in each mode across time subject to a data fitting constraint depending on the noise variance.

min ∥X∥_{0,2}s.t.∥Y−R(T,Θ)\tilde{X}∥₂²≦kσₙ^{w} Equation 15

Equation 16 illustrates a general convex constraint on the residual of the data fit, where Γ is a convex function and E is determined by the convex function, the problem parameters and noise statistics. In some examples, an l_{∞} norm based convex function may be chosen and a problem formulation may be constructed based on the Dantzig selector as represented in Equation 17, where c is a constant depending on the problem parameters. In some examples, the sparsity criterion may be generalized beyond the l_{0,2} based formulation. Referring to Equation 17, the dual basis has been taken corresponding to the Radon transform for a signal representation in R. While an inverse transform may be used as the basis, because of the small array aperture, this inverse may not be well conditioned.

min∥X∥X_{0,2}s.t.∥Γ(Y−R(T,Θ)\tilde{X})≦ε

min∥X∥_{0,2}s.t.∥R(T,Θ)^{†}(Y−R(T,Θ)\tilde{X}∥_{∞}≦cσₙ\sqrt{log N_{Θ}} Equation 17

Because the optimization problem of Equation 16 may be combinatorially difficult even for a small number of modes, Equation 16 may be relaxed, as represented in Equation 18, using a convex relation, where the l₀ norm was replaced with the l₁ norm, i.e., ∥X∥_{1,2}=∥X_{rN}∥₁+Σᵢ₌₁^{m}|X_{rN}|, where X_{rN} is defined as above.

min∥X∥_{1,2}s.t.∥Y−R(T,Θ)\tilde{X}∥₂²≦kσₙ² Equation 18

In some examples, an estimate of σₙ² is not available and the complexity penalized regularization algorithm of Equation 19 is used, where λ is a chosen regularization parameter (e.g., user dependent). If the acquisition environment remains stable for a certain zone, then the regularization parameter may remain fixed for processing the data from that zone without having to recompute the regularization parameter for each frame.

min∥Y−R(T,Θ)\tilde{X}∥₂²+λ∥X∥_{1,2} Equation 19

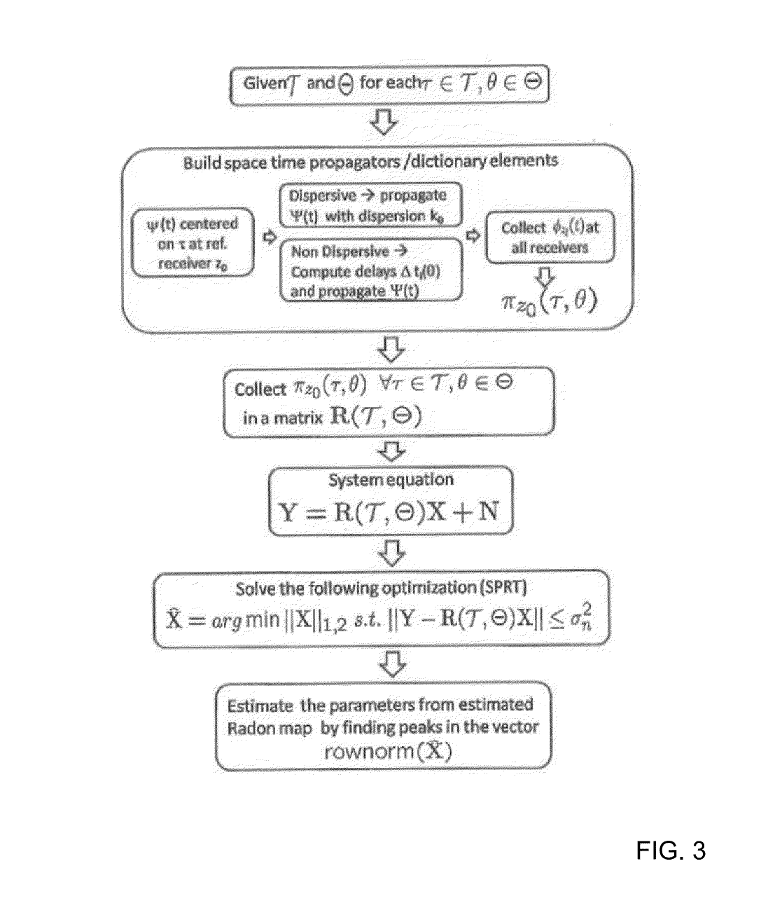

FIG. 3 illustrates an example workflow and/or method for the SPRT method.

Experiments were conducted on synthetic and real data sets associated with fast formations where the tool mode substantially interferes with the compressional mode leading to biased estimates in semblance and traditional Radon based processing.

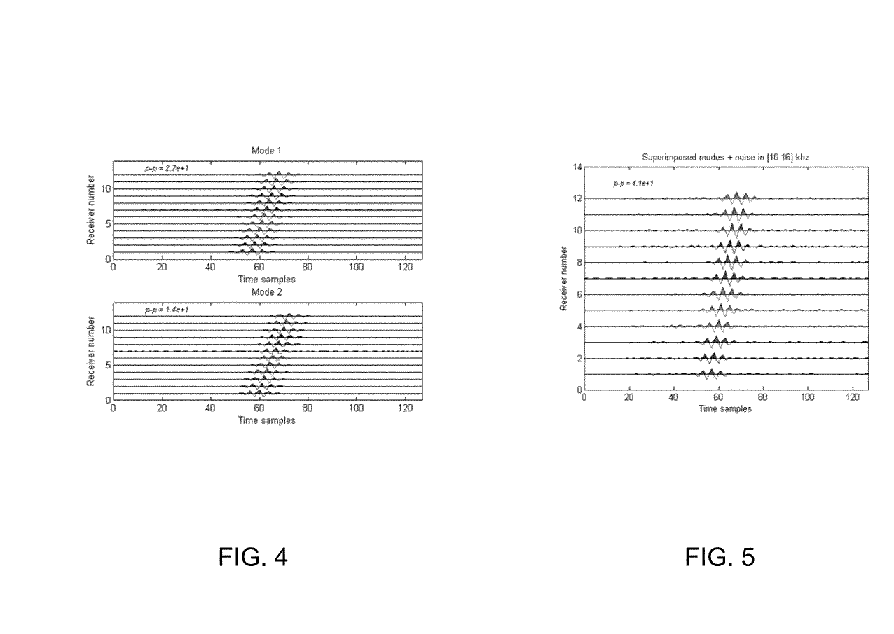

To determine the performance of the examples disclosed herein with regards to synthetic data, the results were compared to slowness-time-coherence processing results used in wireline applications. For some experiments, the results of which are illustrated in FIGS. 4 and 5, two Morlet wavelets with σ=1, w₀=2 and a center frequency of 12 and 13 kHz, respectively, were used. The wavelets were propagated at a slowness of 60 and 68μ−s/ft across a sensor array of 12 with inter-sensor spacing of ⅓ ft. The starting index at the first receiver for two waves is 35 and 37.8 (in time samples) with a sampling period of dt=20 μs, so there is substantial interference. Gaussian noise on the superposition of these propagating waves with an overall SNR of 20-dB was added and the data and the noise was limited to be in the frequency band of [10-16] kHz. FIG. 4 illustrates two synthetic modes propagating at a slowness of 60 and 68 μ−s/ft, where one mode is 6 dB below the other. FIG. 5 illustrates the superposition of the modes and the noise.

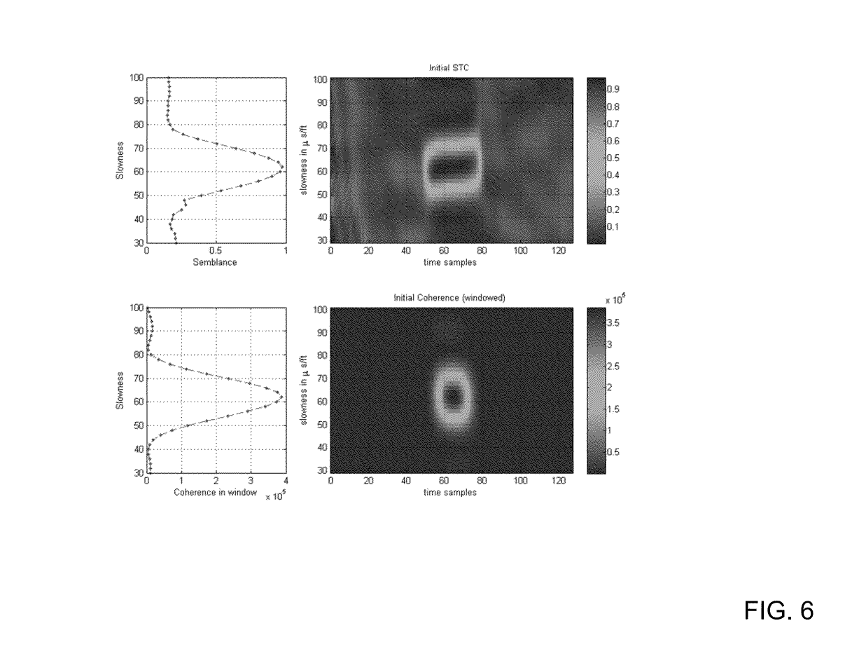

FIG. 6 illustrates the corresponding Radon Transform (RT) and the slowness-time coherence (STC) plots of the noisy synthetic data. Specifically, FIG. 6 illustrates the STC and Coherence projections on the slowness axis showing. Due to low spatial sampling, both the STC and the RT are not able to clearly separate the modes and the slowness estimate of the stronger mode is incorrect.

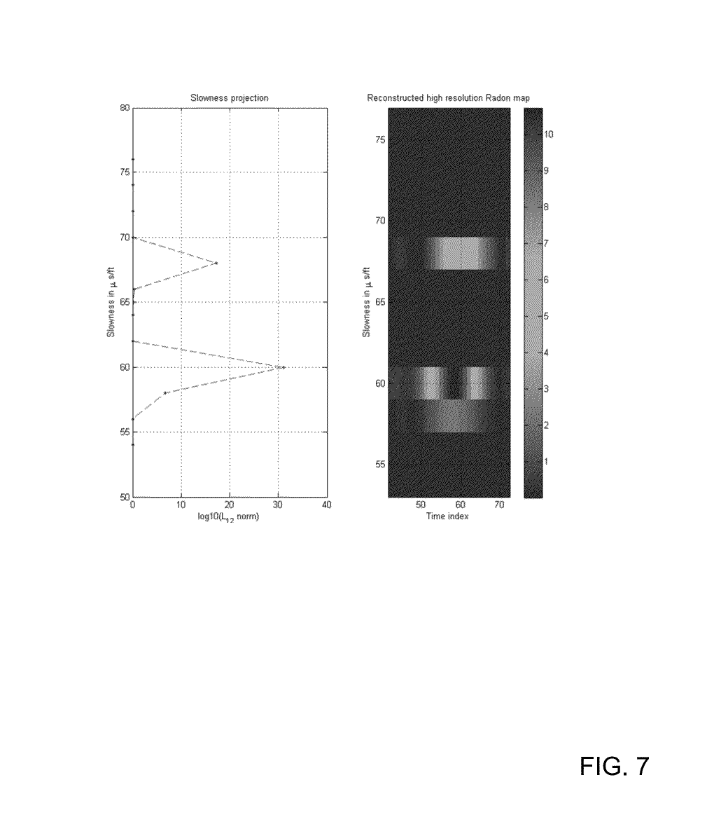

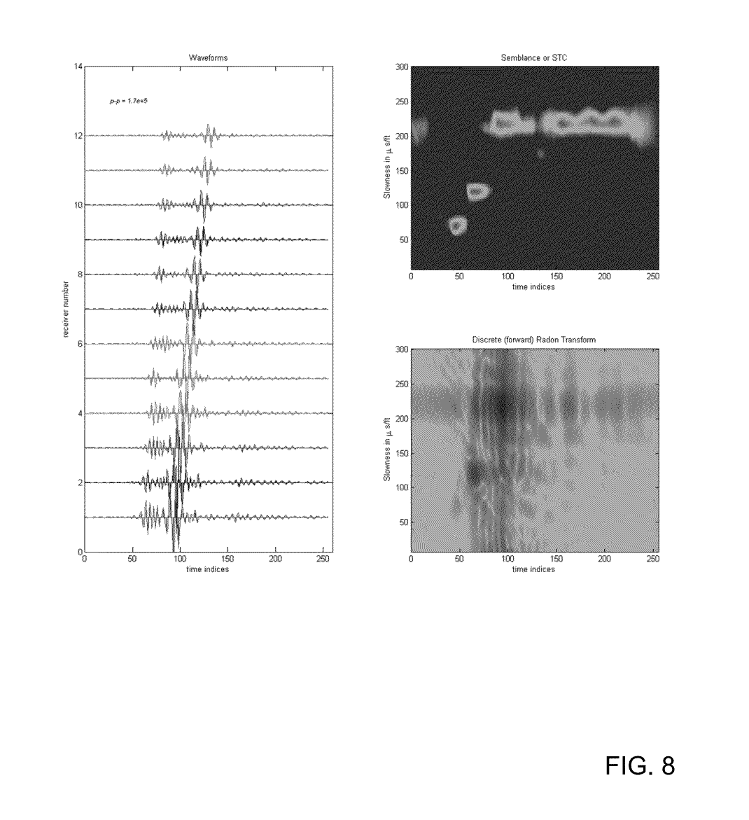

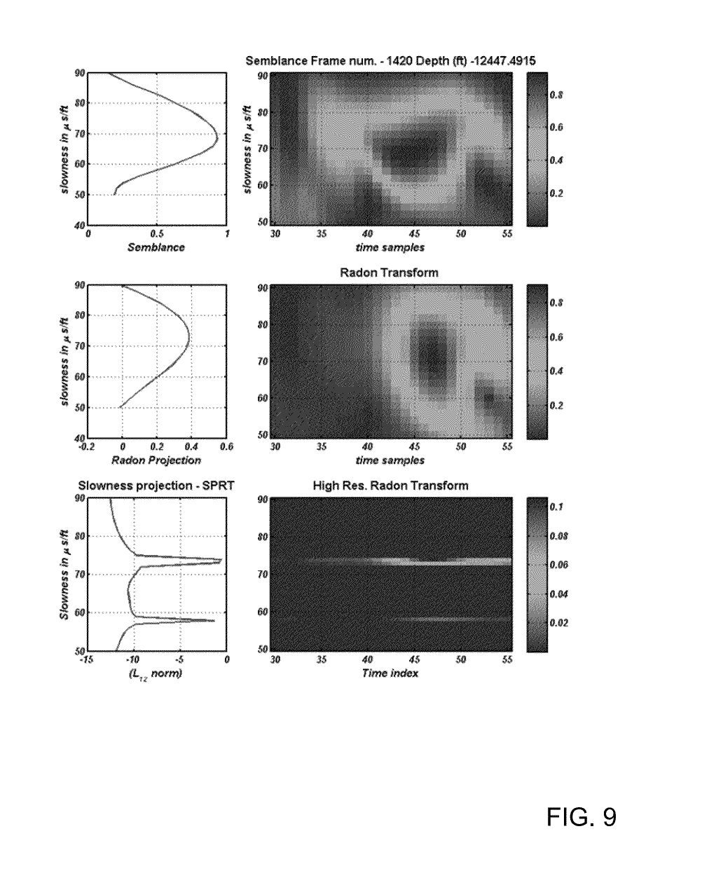

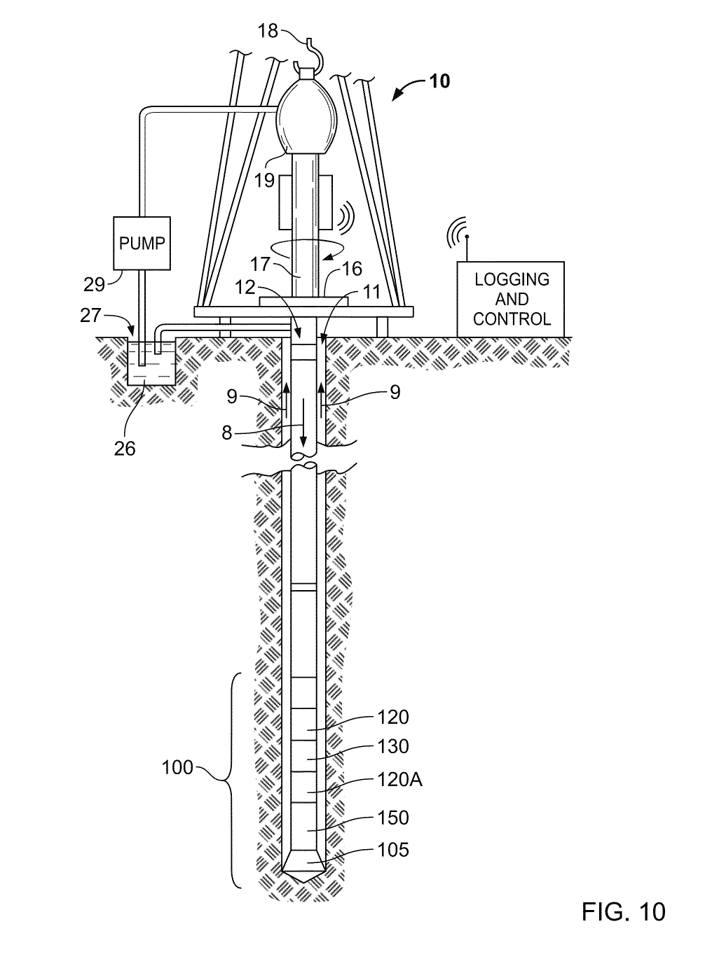

Using the examples disclosed herein, the SPRT method and/or algorithm is used with the noisy data. FIG. 7 represents the results of solving the problem represented by Equation 19 using a CVX library and SEDUMI. As illustrated in FIG. 7, the SPRT method and/or algorithm is used to resolve, distinguish between and/or identify two propagating wavefields and/or waveforms (e.g., recover both modes) in the presence of noise and interference and the slowness estimates were accurate.

To determine the performance of the examples disclosed herein with regards to real data, a data set from a fast formation was obtained corresponding to a LWD monopole P&S logging scenario using the Schlumberger® MP3-475 tool. To demonstrate the high resolution capabilities of the examples disclosed herein, the waveforms are filtered in the 7-16 kHz. Such filtering filters out the dominant Stoneley mode and retains the tool mode. FIG. 7 illustrates an initial semblance and the Radon plot using real data from a LWD monopole logging scenario. As illustrated in the frame of FIG. 7, the Shear arrival is not interfering with the compressional arrival in the time window 30-55 time indices and, thus, the SPRT method and/or algorithm can be applied in the time window to resolve the compressional from the tool arrival.

FIG. 8 illustrates the results of processing real data from the LWD monopole logging scenario using the examples disclosed herein as well as local semblance maps and Radon maps. As compared to the semblance based and Radon based processing, using the SPRT method and/or algorithm enables clear resolution of the tool and compressional modes and the output, solution and/or answer of 72-73 microseconds per feet for the slowness is a clear refinement of the original output, solution and/or answer of 69-70 microseconds per feet.

The examples disclosed relate to methods and apparatus for separating propagating waves and/or modes to identify and/or determine the move-outs and/or slowness dispersions. Such propagating waves and/or modes are associated with borehole seismic and/or sonic data, surface seismic acquisition, low array aperture and/or heavy inter-modal temporal interference. In some examples, a framework is generated and/or provided to represent propagating waves and/or modes using space time propagators. The represented propagating waves may be associated with a representation in a basis that is dual to the Discrete Radon Transform (DRT) basis.

To resolve the modes in the moveout time domain and/or to address heavy intermodal temporal interference, the examples disclosed herein use a Sparsity Penalized Radon Transform (SPRT) that uses sparsity in the move-out and/or slowness dispersion time domain for high resolution detection and/or estimation. SPRT includes constructing an over-complete representation of the data using space time propagators and using a simultaneous sparsity (mixed l₁-l₂ norm) penalized reconstruction algorithm where sparsity is used in the move-out dimension.

The examples disclosed herein relate to processing acoustic waveforms and/or waveform data including closely propagating wavefields and/or waveforms. The waveforms may include weak compressional and tool mode waveforms in Logging while Drilling applications, borehole sonic and seismic data associated with shear wave splitting in anisotropic formations and/or near surface reflections in surface seismic data. The waveforms may be obtained using an array of two more sensors in a borehole acoustic and seismic acquisition set-up for oil and/or gas applications.

To enable high resolution detection and estimation of closely propagating wavefields and/or waveforms moving across a sensor array, the example SPRT method in the Discrete Radon Transform (DRT) and Discrete Generalized Radon Transform domain may be used. While the examples disclosed herein discuss examples using non-dispersive wavefields, the examples disclosed herein may be generally applied to processing waveforms and/or wavefield including, for example, dispersive wavefields with or without non-linear move-outs using Generalized Discrete Radon Transform (GDRT) domain and/or other applications such as biomedical imaging, non-destructive evaluation, etc.

FIG. 10 illustrates a wellsite system in which the examples disclosed herein can be employed. The wellsite can be onshore or offshore. In this example system, a borehole 11 is formed in subsurface formations by rotary drilling. However, the examples described herein can also use directional drilling, as will be described hereinafter.

A drill string 12 is suspended within the borehole 11 and has a bottom hole assembly 100 that includes a drill bit 105 at its lower end. The surface system includes a platform and derrick assembly 10 positioned over the borehole 11. The assembly 10 includes a rotary table 16, a kelly 17, a hook 18 and a rotary swivel 19. The drill string 12 is rotated by the rotary table 16. The rotatory table 16 may be energized by a device or system not shown. The rotary table 16 may engage the kelly 17 at the upper end of the drill string 12. The drill string 12 is suspended from the hook 18, which is attached to a traveling block (also not shown). Additionally, the drill string 12 is positioned through the kelly 17 and the rotary swivel 19, which permits rotation of the drill string 12 relative to the hook 18. Additionally or alternatively, a top drive system may be used to impart rotation to the drill string 12.

In this example, the surface system further includes drilling fluid or mud 26 stored in a pit 27 formed at the well site. A pump 29 delivers the drilling fluid 26 to the interior of the drill string 12 via a port in the swivel 19, causing the drilling fluid 26 to flow downwardly through the drill string 12 as indicated by the directional arrow 8. The drilling fluid 26 exits the drill string 12 via ports in the drill bit 105, and then circulates upwardly through the annulus region between the outside of the drill string 12 and the wall of the borehole 11, as indicated by the directional arrows 9. In this manner, the drilling fluid 26 lubricates the drill bit 105 and carries formation cuttings up to the surface as it is returned to the pit 27 for recirculation.

The bottom hole assembly 100 of the example illustrated in FIG. 10 includes a logging-while-drilling (LWD) module 120, a measuring-while-drilling (MWD) module 130, a roto-steerable system and motor 150, and the drill bit 105.

The LWD module 120 may be housed in a special type of drill collar and can contain one or more logging tools. In some examples, the bottom hole assembly 100 may include additional LWD and/or MWD modules. As such, references throughout this description to reference numeral 120 may additionally or alternatively include 120A. The LWD module 120 may include capabilities for measuring, processing, and storing information, as well as for communicating with the surface equipment. Additionally or alternatively, the LWD module 120 includes a sonic measuring device.

The MWD module 130 may also be housed in a drill collar and can contain one or more devices for measuring characteristics of the drill string 12 and/or drill bit 105. The MWD module 130 further may include an apparatus (not shown) for generating electrical power for at least portions of the bottom hole assembly 100. The apparatus for generating electrical power may include a mud turbine generator powered by the flow of the drilling fluid. However, other power and/or battery systems may be employed. In this example, the MWD module 130 includes one or more of the following types of measuring devices: a weight-on-bit measuring device, a torque measuring device, a vibration measuring device, a shock measuring device, a stick slip measuring device, a direction measuring device and/or an inclination measuring device.

Although the components of FIG. 10 are shown and described as being implemented in a particular conveyance type, the examples disclosed herein are not limited to a particular conveyance type but, instead, may be implemented in connection with different conveyance types include, for example, coiled tubing, wireline wired drillpipe and/or any other conveyance types known in the industry.

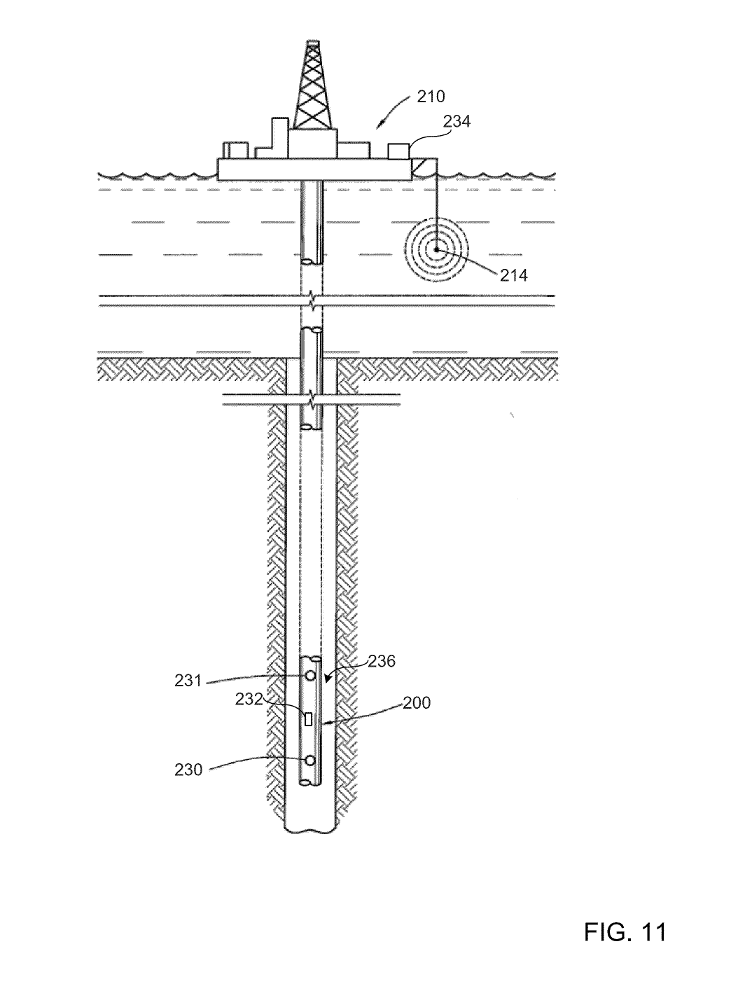

FIG. 11 illustrates a sonic logging-while-drilling tool that can be used to implement the LWD tool 120 or may be a part of an LWD tool suite 120A of the type described in U.S. Pat. No. 6,308,137, which is hereby incorporated herein by reference in its entirety. An offshore rig 210 having a sonic transmitting source or array 214 may be deployed near the surface of the water. Additionally or alternatively, any other type of uphole or downhole source or transmitter may be provided to transmit sonic signals. In some examples, an uphole processor controls the firing of the transmitter 214.

Uphole equipment can also include acoustic receivers (not shown) and a recorder (not shown) for capturing reference signals near the source of the signals (e.g., the transmitter 214). The uphole equipment may also include telemetry equipment (not shown) for receiving MWD signals from the downhole equipment. The telemetry equipment and the recorder are may be coupled to a processor (not shown) so that recordings may be synchronized using uphole and downhole clocks. A downhole LWD module 200 includes at least acoustic receivers 230 and 231, which are coupled to a signal processor so that recordings may be made of signals detected by the receivers in synchronization with the firing of the signal source.

In operation, the transmitter 214 transmits signals and/or waves that are received by one or more of the receivers 230, 231. The received signals may be recorded and/or logged to generate associated waveform data. The waveform data may be processed by processors 232 and/or 234 to remove noise, interference and/or identify waveforms as disclosed herein.

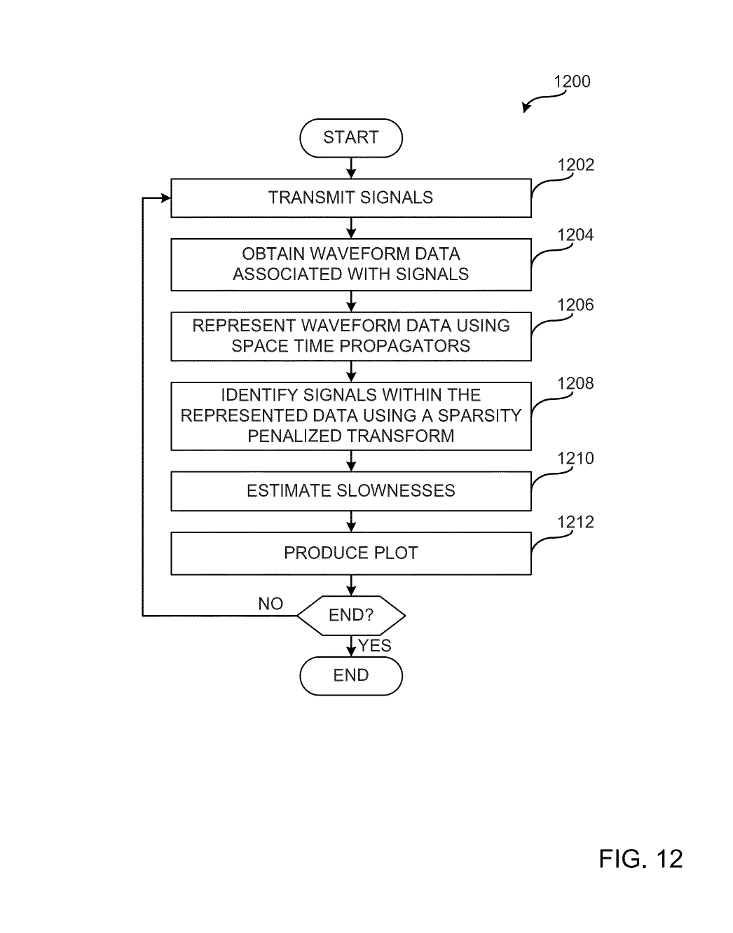

FIG. 12 depicts an example flow diagram representative of processes that may be implemented using, for example, computer readable and executable instructions that may be used to identify and/or distinguish between waveform data. The example processes of FIG. 12 may be performed using a processor, a controller and/or any other suitable processing device. For example, the example processes of FIG. 12 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 12 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 12 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 12 may be implemented manually or as any combination(s) of any of the foregoing techniques, for example, any combination of firmware, software, discrete logic and/or hardware. Further, although the example processes of FIG. 12 are described with reference to the flow diagram of FIG. 12, other methods of implementing the processes of FIG. 12 may be employed. For example, the order of execution of the blocks may be changed, and/or some of the blocks described may be changed, eliminated, sub-divided, or combined. Additionally, any or all of the example processes of FIG. 12 may be performed sequentially and/or in parallel by, for example, separate processing threads, processors, devices, discrete logic, circuits, etc.

The example process 1200 of FIG. 12 may begin by transmitting a signal from one or more transmitters and/or sources (block 1202) and receiving the signal at one or more receivers spaced from the transmitters. In some examples, the source may be one or more monopole sources and/or multi-pole sources.

The received signals may be recorded and/or logged to generate waveform data associated with the signals (block 1204). The process 1200 may then represent the waveform data using space time propagators in the Discrete Radon Transform Domain (block 1206). In some examples, representing the waveform data using the space time propagators includes representing the waveform data as a superposition of the propagating wave fields.

The weak signals within the waveform data may be identified using a Sparsity Penalized Transform (blocks 1208). The processed waveform data is then processed to estimate slowness such as compressional slowness and a plot such as a high resolution slowness plot may be produced (blocks 1210, 1212).

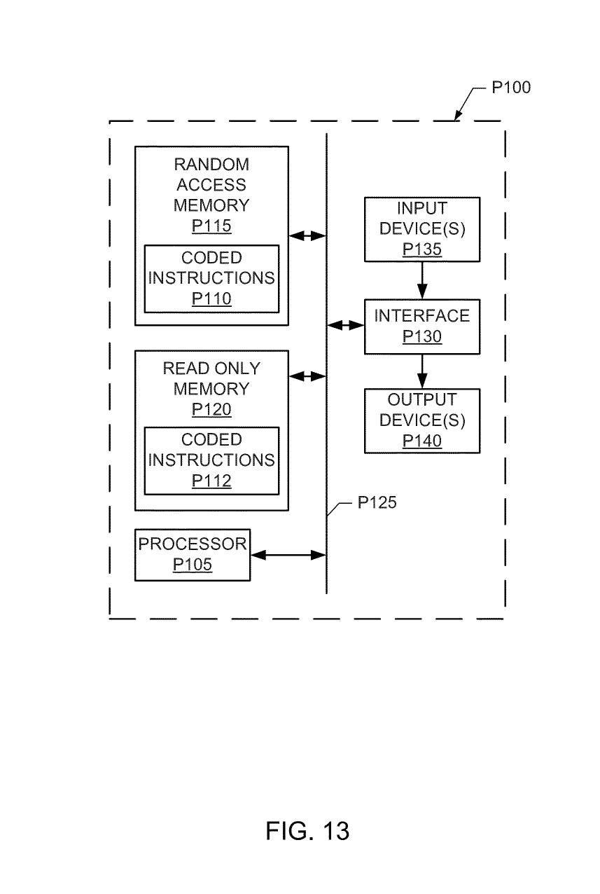

FIG. 13 is a schematic diagram of an example processor platform P100 that may be used and/or programmed to implement to implement a logging and control computer (FIG. 13), the processors 232 and/or 234 and/or any of the examples described herein. For example, the processor platform P100 can be implemented by one or more general purpose processors, processor cores, microcontrollers, etc.

The processor platform P100 of the example of FIG. 13 includes at least one general purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example methods and apparatus described herein.

The processor P105 is in communication with the main memory (including a ROM P120 and/or the RAM P115) via a bus P125. The RAM P115 may be implemented by dynamic random-access memory (DRAM), synchronous dynamic random-access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general purpose input/output, etc. One or more input devices P135 and one or more output devices P140 are connected to the interface circuit P130.

As set forth herein, an example method includes representing waveform data using space time propagators in the Discrete Radon Transform Domain and identifying signals within the represented waveform data using a Sparsity Penalized Transform. In some examples, the signals include weak signals. In some examples, the signals include compressional waveforms, tool mode waveforms, borehole sonic or seismic data associated with shear wave splitting, or near surface reflections in surface seismic data. In some examples, the method includes estimating slowness of the identified signals. In some examples, the method includes producing a time slowness plot using the estimated slownesses.

In some examples, the method includes filtering the waveform data. In some examples, using the Sparsity Penalized Transform includes using sparsity in the move-out dimension. In some examples, representing waveform data using space time propagators includes representing the waveform data as a superposition of time compact space time propagators.

An example method includes processing waveform data using a processor to identify one more weak signals in the waveform data. The weak signals to be identified using a Sparsity Penalized Transform. In some examples, the Sparsity Penalized Transform is to identify the weak signals using waveform data represented in the Discrete Radon Transform domain. In some examples, the waveform data is represented using space time propagators. In some examples, representing the waveform data includes representing the waveform data as a superposition of the space time propagators. In some examples, processing the waveform data includes processing the waveform data in substantially real time. In some examples, using the Sparsity Penalized Transform comprises using sparsity in the move-out dimension.

An example apparatus includes one or more sources spaced from receivers. The one or more sources to transmit one or more signals and the receivers to receive at least a portion of the one or more signals. The example apparatus includes a processor to process waveform data to identify one or more weak signals in the waveform data. The waveform data associated with the one or more signals. The weak signals to be identified using a Sparsity Penalized Transform.

In some examples, the processor is to identify the weak signals using waveform data represented in the Discrete Radon Transform domain. In some examples, the waveform data is represented as a superposition of the space time propagators. In some examples, the processor is to generate a Radon map based on the processed waveform data. In some examples, the processor is to generate a time slowness plot based on the processed waveform data. In some examples, the processor is to estimate slowness of the weak signals.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
representing waveform data using space time propagators in the Discrete Radon Transform Domain; and
identifying signals within the represented waveform data using a Sparsity Penalized Transform.

2. The method of claim 1, wherein the signals comprise weak signals.

3. The method of claim 1, wherein the signals comprise compressional waveforms, tool mode waveforms, borehole sonic or seismic data associated with shear wave splitting, or near surface reflections in surface seismic data.

4. The method of claim 1, further comprising estimating slowness of the identified signals.

5. The method of claim 4, further comprising producing a time slowness plot using the estimated slownesses.

6. The method of claim 1, further comprising filtering the waveform data.

7. The method of claim 1, wherein using the Sparsity Penalized Transform comprises using sparsity in the move-out dimension.

8. The method of claim 1, wherein representing waveform data using space time propagators comprising representing the waveform data as a superposition of time compact space time propagators.

9. A method, comprising:
processing waveform data using a processor to identify one more weak signals in the waveform data, the weak signals to be identified using a Sparsity Penalized Transform.

10. The method of claim 9, wherein the Sparsity Penalized Transform is to identify the weak signals using waveform data represented in the Discrete Radon Transform domain.

11. The method of claim 10, wherein the waveform data is represented using space time propagators.

12. The method of claim 11, wherein the representing the waveform data comprising representing the waveform data as a superposition of the space time propagators.

13. The method of claim 9, wherein processing the waveform data comprises processing the waveform data in substantially real time.

14. The method of claim 9, wherein using the Sparsity Penalized Transform comprises using sparsity in the move-out dimension.

15. An apparatus, comprising,
one or more sources spaced from receivers, the one or more sources to transmit one or more signals and the receivers to receive at least a portion of the one or more signals; and
a processor to process waveform data to identify one or more weak signals in the waveform data, the waveform data associated with the one or more signals, the weak signals to be identified using a Sparsity Penalized Transform.

16. The apparatus of claim 15, wherein the processor is to identify the weak signals using waveform data represented in the Discrete Radon Transform domain.

17. The method of claim 15, wherein the waveform data is represented as a superposition of the space time propagators.

18. The apparatus of claim 15, wherein the processor is to generate a Radon map based on the processed waveform data.

19. The apparatus of claim 15, wherein the processor is to generate a time slowness plot based on the processed waveform data.

20. The apparatus of claim 15, wherein the processor is to estimate slowness of the weak signals.
